(19) United States
(12) Patent Application Publication
(10) Pub. No.: US 2019/0321888 A1
(43) Pub. Date: Oct. 24, 2019

(54) APPARATUS FOR DISPENSING CONTENT

(71) Applicant: Tytus3D System Inc., Fremont, CA (US)

(72) Inventors: Ilgoo HWANG, San Jose, CA (US); Jerald YUN, Pleasanton, CA (US); Hon S. YI, San Jose, CA (US)

(73) Assignee: Tytus3D System Inc.

(21) Appl. No.: 16/388,843

(22) Filed: Apr. 18, 2019

Related U.S. Application Data
(60) Provisional application No. 62/659,570, filed on Apr. 18, 2018.
(60) Provisional application No. 62/659,580, filed on Apr. 18, 2018.

(51) Int. Cl. B22F 3/105; B33Y 30/00

(52) U.S. Cl. CPC B22F 3/1055; B22F 2003/1056; B33Y 30/00

(57) ABSTRACT

Disclosed is an adapter for dispensing content to minimize exposure to ambient air. The adapter introduces an inflatable sealing mechanism by comprising a container having open ends on top and bottom of the container, a piercing unit to perforate a seal of a factory sealed content bottle, a conduit configured to fluidize contents in the first factory sealed content bottle through providing inert gas, a cap coupled to the open end on top of the container and an inflatable bladder configured to seal the first factory sealed content bottle while transferring the contents into a second bottle or a valve. The adapter further introduces a thread engaging sealing mechanism by adding a screw thread inside an open neck on top of the container. The bottom of the container is coupled to a second bottle or a valve.

### CROSS-REFERENCE TO A RELATED APPLICATION

This application is a nonprovisional of claims the benefit of and priority to U.S. Provisional Patent Application No. 62/659,570, filed Apr. 18, 2018, inventors Ilgoo Hwang et al., titled “A UNIVERSAL CONTAINER ADAPTOR FOR MINIMIZING CONTENT EXPOSURE TO AMBIENT GAS WITH INFLATABLE SEALING MECHANISM” and U.S. Provisional Patent Application No. 62/659,580, filed Apr. 18, 2018, inventors Ilgoo Hwang et al., titled “A UNIVERSAL CONTAINER ADAPTOR FOR MINIMIZING CONTENT EXPOSURE TO AMBIENT GAS WITH THREAD LID SEALING MECHANISM” which are commonly assigned herewith, and all of which are hereby incorporated herein by reference in its entirety with the same full force and effect as if set forth in its entirety herein.

### FIELD OF THE INVENTION

The present disclosure generally relates to additive manufacturing, and more particularly, to an apparatus of minimizing exposure to ambient gas when one or more contents are transferring from a factory sealed bottle into a bottle which is designated standard for a machine.

### BACKGROUND OF THE INVENTION

Additive manufacturing is the process of building a part by consolidating layers of material progressively onto the substrate. Powder-bed based additive manufacturing is a class of additive manufacturing (AM) processes that bond successive layers of powder by laser sintering to facilitate the fabrication of parts with complex structures. The layers of material can be a powder which is melted by a laser beam to fuse it onto the underlying substrate.

In general, a powder delivery system for a powder-bed based additive manufacturing process includes an any form of container of the part of the powder dispenser, such as hopper, big bags, silos, drums or others, adapted to store a powder and continuously to feed the powder through an output of the powder feeder. The powder feeder is used to discharge powder onto a powder bed which is subsequently scraped to a very thin and flat layer. This process is to say for preparing the bed of powder, prior to sinter or to melt of the powder layer using laser energy.

Powdered metal alloy can be used to form a multitude of materials and shaped objects in additive manufacturing. Powder-bed fusion technology uses a range of metal powders including nickel alloys, titanium alloys, cobalt chromium, aluminum alloys, magnesium alloys, copper alloys, and others. Some alloys are highly sensitive to oxygen and hydrogen impurity during the process. Because of this reason, it is mandatory to control precisely and hold a low oxygen level while processing a metal three-dimensional printing.

Conventionally, an operator places the factory sealed bottle that sealed at the powder manufacturer's ambient gas controlled facility above the opening of the feeder, such as hopper. When an operator extracts powders from the factory sealed bottle, powder characteristics are not modified during transfer, but may be contaminated by oxygen or humid air at the work site. Metal oxides, metal hydroxides, or other collateral damages may be created incidentally.

The presence of such oxides harmfully effects on one or more of the properties of the products made from such metal powders. Problems are occurred from, for example, surface contamination with pre-alloyed powder, and particles such as carbides, oxy-carbo-nitrides, oxides, oxy-carbides, or others.

Accordingly, there is a need for an economical apparatus and method to minimize exposure to ambient gas which may contaminate contents, when the content is transferred from a factory sealed bottle to a powder feeder.

### BRIEF DESCRIPTION OF THE DRAWINGS

The objects, features and advantages of the present invention will be more readily appreciated upon reference to the following disclosure when considered in conjunction with the accompanying drawings, wherein like reference numerals are used to identify identical components in the various views, and wherein reference numerals with alphabetic characters are utilized to identify additional types, instantiations or variations of a selected component embodiment in the various views, in which:

FIG. 1 (or “FIG. 1”) is a schematic isometric view of an embodiment of an adapter for dispensing content with inflatable sealing mechanism to minimize exposure to ambient gas at initial position,

FIG. 2A (or “FIG. 2A”) is a partial perspective view showing a use of the adapter for dispensing content with inflatable sealing mechanism of the present invention with a factory sealed content bottle,

FIG. 2B (or “FIG. 2B”) is another scenario of a partial perspective view showing a use of the adapter for dispensing content with inflatable sealing mechanism of the present invention with the factory sealed content bottle,

FIG. 3 (or “FIG. 3”) is a schematic isometric view of an embodiment of the adapter for dispensing content with inflatable sealing mechanism at activated position,

FIG. 4 (or “FIG. 4”) is a schematic isometric view of an embodiment of adapter for dispensing content with threaded sealing mechanism to minimize exposure to ambient gas,

FIG. 5A (or “FIG. 5A”) is an elevation view, partially in cross-section, of an embodiment of the inflatable content dispensing adaptor with an optional sieve plate and a vibrator of the present invention,

FIG. 5B (or “FIG. 5B”) is an elevation view, partially in cross-section, of an embodiment of the inflatable content dispensing adaptor with an optional sieve plate of the present invention, and

FIGS. 6A to 6C (or “FIGS. 6A, 6B and 6C”) are schematic cross-sectional views depicting assembly steps of an embodiment with the adapter for dispensing content with threaded sealing mechanism utilizing a seal piercing unit and a conduit.

### DETAILED DESCRIPTION OF REPRESENTATIVE EMBODIMENTS

The present disclosure is to be considered as an exemplification of the principles of the invention and is not intended to limit the invention to the specific embodiments illustrated. In this respect, it is to be understood that the invention is not limited in its application to the details of construction and to the arrangements of components set forth above and below, illustrated in the drawings, or as described in the examples. Systems, methods and apparatuses consistent with the present invention are capable of other embodiments and of being practiced and carried out in various ways.

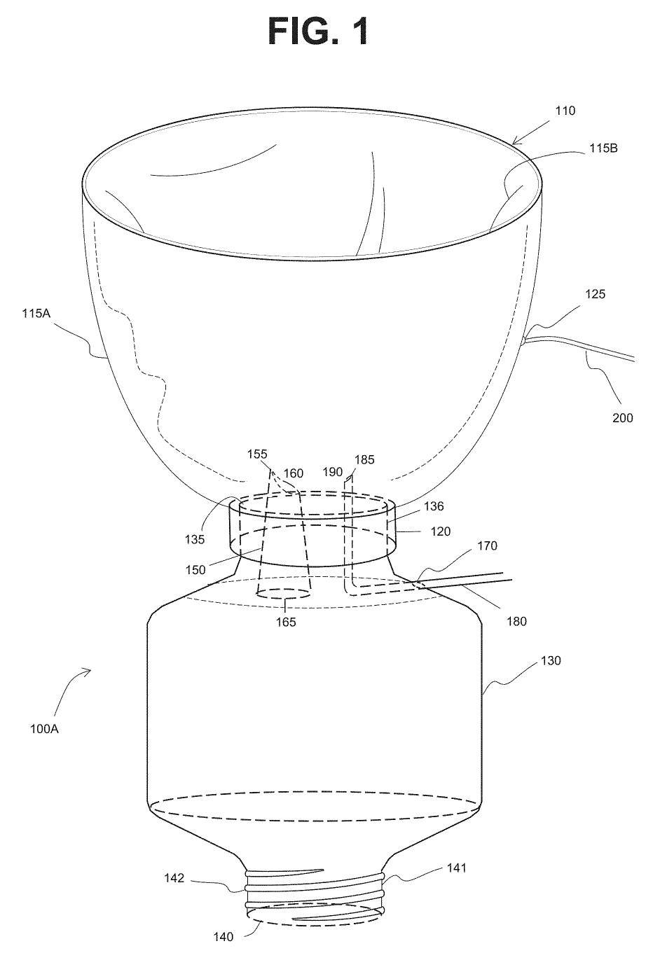

Referring now to FIG. 1, an adapter for dispensing content with inflatable sealing mechanism 100A to minimize exposure to ambient gas at initial position according to one aspect of the present invention is shown. The adapter 100 has a double ended container 130 having a first open end 135 on top of the container 130 and a second open end 140 on bottom of the container 130, wherein the first open end 135 is on a first neck 136 at upper portion of the container 130, and a second open end 140 is on a second neck 141 at lower portion of the container 130. The adapter 100 includes an inflatable bladder 110 which attached to a cap 120 that covers the first open end 135 and a first neck 138 of the container 130. The material of the cap 120 may be made of rubber, silicon, plastic, wood, stainless steel, but not limited to. The inflatable bladder 110 includes a rigid outer shell 115A, an inflatable soft inner shell 115B, and an aperture 125 on the outer shell 115A subject to pressurize ambient air or gas 250 to inflate in. The aperture 125 may further include a hose or tube 200 connected to an air pump or other pressurizing equipment, so that the inner soft shell 115B inwardly become inflatable. At the upper portion of the container 130, a piercing unit 150 and a conduit 180 are introduced, wherein the piercing unit has a lower open end 165 and a sharp tip 155 at upper open end 160, and the conduit 180 in an L-shaped frame, but not limited to, has a sharp tip 185 at proximal end. The L-shaped frame that penetrates a side wall of the container 130 configured to provide gas 500 into the factory sealed content bottle 300. The second neck 141 at lower portion of the container 130 and the second open end 140 on bottom of the container 130 are configured to connect to a bottle 430 which is a designated standard one to be used in a specific machine or system, or other environment. In some implements, the bottle 430 may be coupled to a valve 400A and 400B according to a machine's specification prior to connect to a container 130.

In some implements, the conduit 180 passes through an aperture 170 on the container 130, and the aperture 170 through which the conduit passes is sealed to prevent external ambient air from entering the container and the factory sealed content bottle. In some instances, inert gas 500, e.g., nitrogen gas or argon gas, but not limited to, is provided into the factory sealed content bottle 300. In the exemplary embodiment of the invention, the diameter of the lower open end of the piercing unit is greater than that of the upper open end 160.

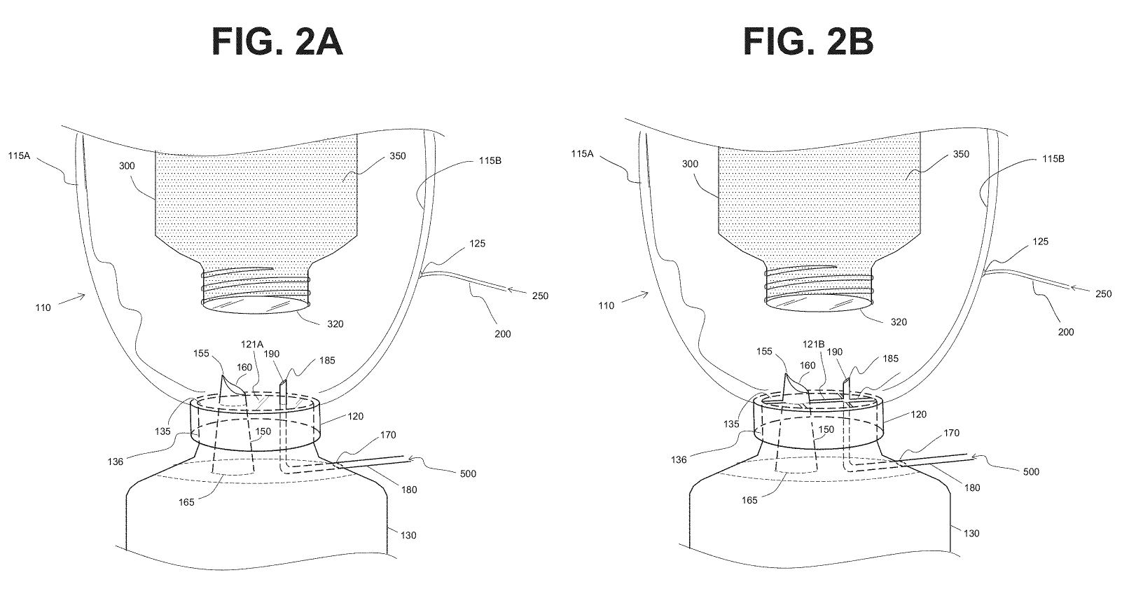

The embodiment of FIG. 2A is a partial perspective view showing a use of the adapter for dispensing content with inflatable sealing mechanism 100A of the present invention with a factory sealed content bottle 300. The factory sealed content bottle 300 includes a sealing 320 on top of the bottle 300. The sealing 320 generally is firmly attached to the top of the bottle 300 even after a cap is removed, and the inner contents 350 are not exposed to the air due to the sealing 320. The factory initiated status does not expose to any air yet. A user may insert the factory sealed content bottle 300 into the adapter for dispensing content with inflatable sealing mechanism 100A, with the sealing 320 facing the piercing unit 150 and the conduit 180, to transfer the contents 350 to the designated bottle 430 through the adapter 100. The sharp tips 185 and 155 at the conduit 180 and the piercing unit 150 are configured to tear a sealing 320 of a factory sealed content bottle 300. In the exemplary embodiment of the present invention, the cap 120 may fix the piercing unit 150 and the conduit 180, support the factory sealed content bottle while transferring the contents, and may prevent the transmission of contents and air not passing through the piercing unit 150 and the conduit 180. In some instances, the cap may secure the piercing unit 150 and the conduit 180, and may also support the factory sealed content bottle 300 while transferring the contents 350.

Another partial perspective view showing a use of the adapter for dispensing content with inflatable sealing mechanism 100A of the present invention with a factory sealed content bottle 300 is shown in FIG. 2B. In some instances, the cap may optionally be formed in the shape of a cross-union support fixture, but not limited to, that is configured to secure the piercing unit 150 and the conduit 180, and may also support the factory sealed content bottle 300 while transferring the contents 350. In that case, the lower end 165 of the piercing unit 150 may extend to the side wall of the container 130.

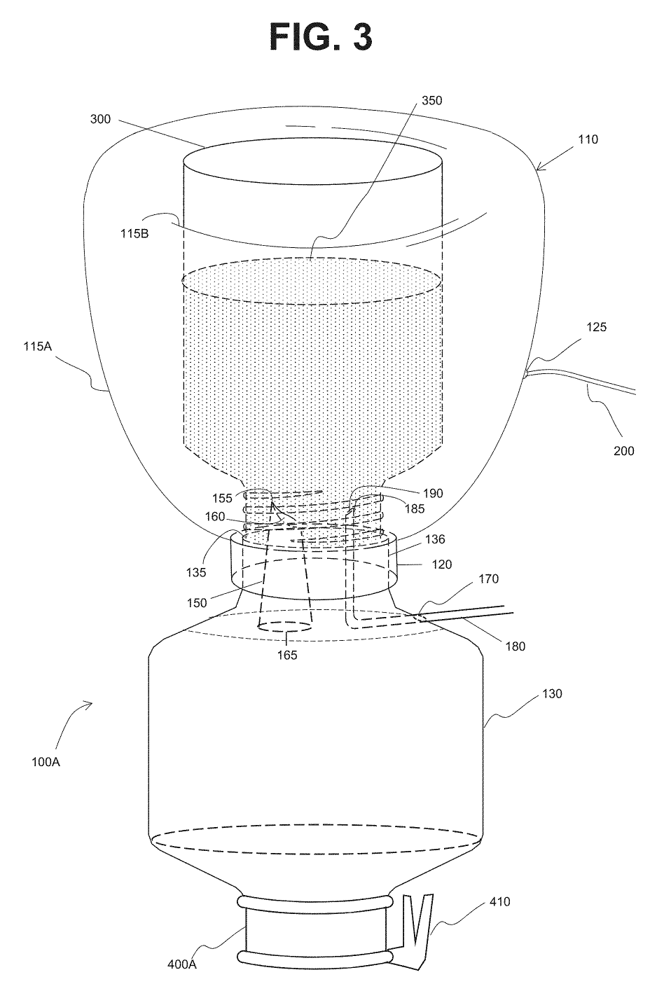

The inflatable bladder 110 is needed to be activated, or pressurized immediately, when the sealing 320 of the factory sealed content bottle 300 is placed on the piercing unit 150 and the conduit 180. Once the inflatable bladder is pressurized and the soft inner shell is expanded in a very short time, the inflated bladder 110 may surround a neck and a body of the factory sealed content bottle 300, in partial, of the factory sealed content bottle 300 accordingly. A schematic isometric view of an embodiment of the adapter for dispensing content with inflatable sealing mechanism 100A at activated position is as shown in FIG. 3. The inflated bladder 110 further has a rigid outer shell 115A, an expandable inner shell 115B, and the expandable inner shell 115B of the bladder 110 extends inwardly by pressurizing air or gas through an aperture 125 on the side wall of the inflatable bladder 110. The material of the expandable inner shell may be made of rubber, silicone, or any materials having good plasticity characters by pressurizing air or gas. This enables the bladder 110 to surround diverse shape of the factory sealed content bottle 300 or any container 200. The inflatable bladder 110 is configured to inflate, and to seal surround the factory sealed content bottle to minimize exposures to ambient gas, e.g., transferring the powder to a designated container that meets a machine specification, before perforating the sealing and during transferring contents to a container or bottle. The inflatable bladder 110 is configured to inflate, and to seal surround the factory sealed content bottle to minimize exposures to ambient gas, right before perforating the sealing of the factory sealed bottle with the piercing unit as well as during transferring contents to a container (e.g., transferring the powder to a designated container that meets a machine specification). This inflating sealing step is for minimizing powder's exposure to ambient gas by sealing the factory sealed content bottle 300, using an inflatable bladder 110. When pressurizing air or gas 250 into the inflatable bladder through the aperture 125, a hose or valve 200 may be used, but not limited to.

FIG. 3 is a schematic isometric view of an embodiment of the adapter for dispensing content with inflatable sealing mechanism 100A at activated position. As described above, the sharp tip 155 of the piercing unit 150 and the sharp tip 185 of the conduit 180 are adapted for perforating the sealing 320 of the factory sealed content bottle 300. The piercing unit 150 has a sharp tip 155 at upper open end of the unit 150, which configured to perforate the sealing 320 easily, therefore the contents, such as powders contained within the bottle 350, can be transferred downwardly through the perforated sealing and the open ended piercing units 160 and 165. The diameter of the lower open end 165 of the piercing unit 150 is greater than that of the upper open end 160 of the piercing unit 150. The conduit 180 is configured to accelerate or help extracting contents or powders 350 by fluidizing the content 350 by pressurize inert gas into the factory sealed content bottle 300, wherein the conduit 180 is extending through an aperture 170 on the side wall of the container 130. The piercing unit 150 and the conduit 180 are rise above the top 135 of the container 130, so they could perforate the sealing 320 using their sharp tips 155, 185. Prior to perforate the sealing 320 by the sharp tips 155, 185, it is necessary to pressurize ambient air or gas 250 into the inflatable bladder 110 after placing the bottle 300 onto the piercing unit 150 and the conduit 180 but before perforating the sealing 320 of the factory sealed content bottle 300. As the bladder 110 is inflated and capable to seal and surround the factory sealed content bottle 300, press the factory sealed content bottle 300 downwardly and let the sharp tips 155, 185 perforate the seal 320 of the factory sealed content bottle 300. In some instances, the top surface of cap may be positioned slightly lower than the top of the first neck 136 of the container 130. The contents 350 of the factory sealed content bottle 300 initiated to transfer through the upper open end 160 and the lower open end 165 of the piercing unit 150, pass through the container 130, and delivered to a customized designated bottle 430. In some instances, a closing valve 400A may be attached to the second open end 140 of the container 130.

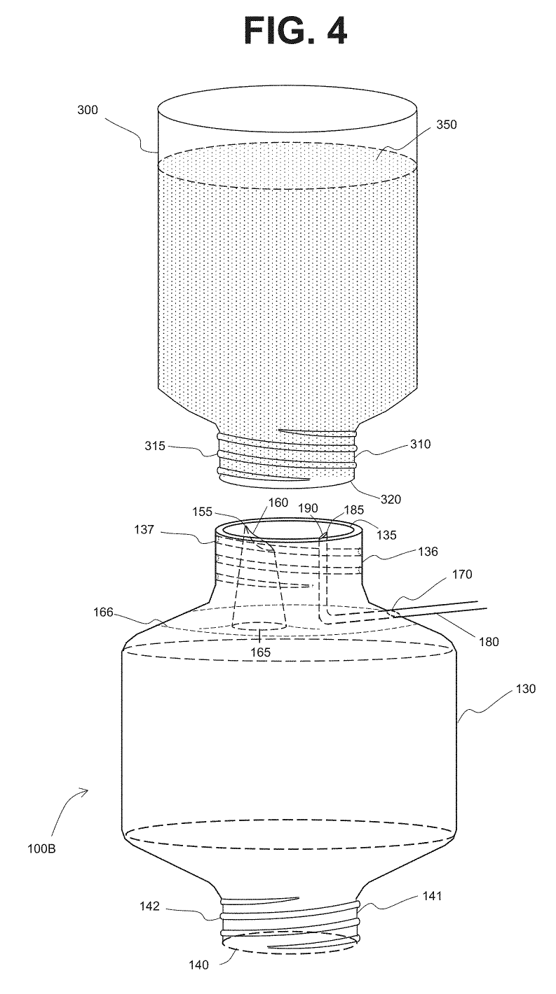

A contents dispensing adaptor may have a different form of inlet, e.g., a threaded inlet, as shown in FIG. 4. The embodiment of FIG. 4 is a schematic isometric view of an embodiment of the adapter for dispensing content with threaded sealing mechanism 100B to minimize exposure to ambient gas. The adaptor 100 with a threaded sealing mechanism has a double ended container 130 having a first open end 135 on a first neck 136 at upper portion of the container 130 and a second open end 140 on second neck 141 at lower portion of the container 130, an internal screw thread 137 on the first neck 136 to engage with an external screw thread 315 of a neck 310 of the factory sealed content bottle 300, a piercing unit 150 having a sharp tip 155 at upper open end of the unit 150, and a conduit 180 having a sharp tip 185 at proximal end for communicating inert gas 500 to the factory sealed content bottle 300 through an aperture 170 on the side wall of the container 130. The second open end 140 is coupled to a second container 430, such as a designated powder bottle which meets a certain machine specification, etc., or one or more valves 400A, 400B to couple with the second bottle 430.

In some instances, the diameter of the first open end 135 may have a specification that can be engaged with the diameter of the inlet of the factory sealed content bottle 130, so that the threads can be engaged with each other, and also the diameter of the second open end 140 may have a specification that can be engaged with the diameter of the second bottle (such as a designated powder bottle which meets a certain machine specification), so that the threads can be engaged with each other.

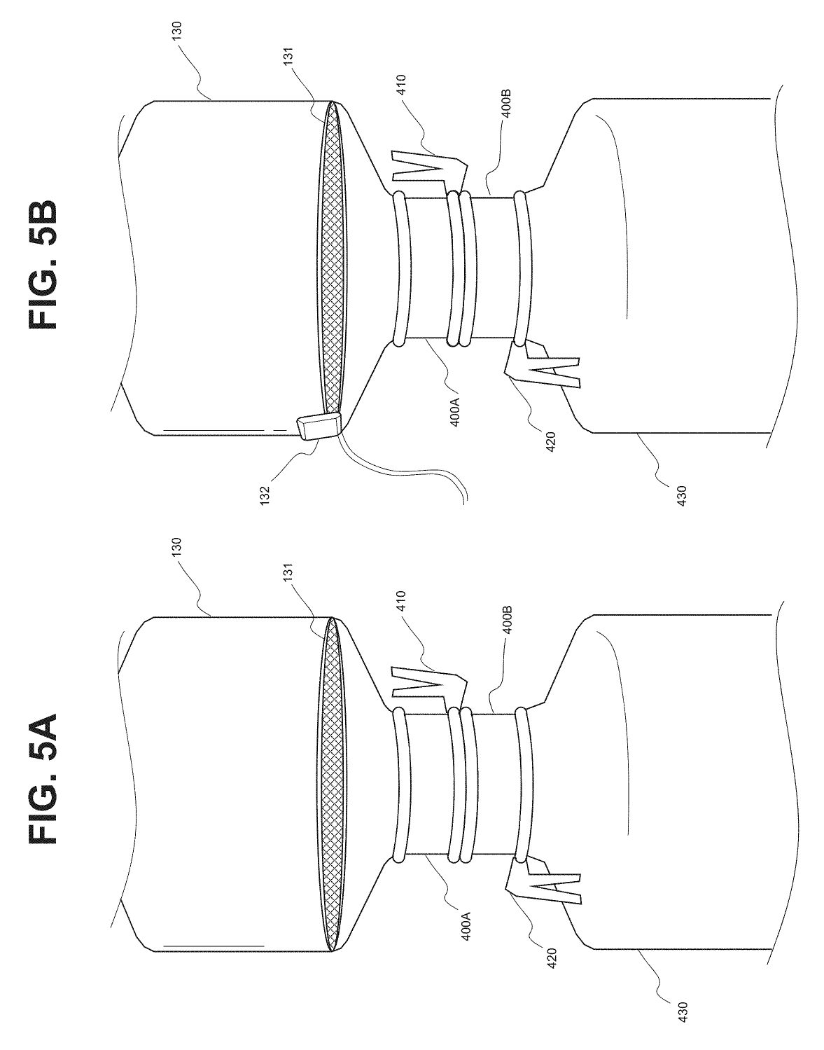

On one hand, a sieve plate 131 may be placed at lower portion of the container 130 optionally. Referring to FIGS. 5A and 5B, the sieve plate 131 is configured to filter debris from any pierced or torn sealing 320 and also to break up agglomerated particles from the content 350.

A vibration imparting device 132 attached to the outer container 130 may be installed thereto additionally, as shown in FIG. 5B. The vibration imparting device 132 is to generates vibration and to transmit the vibration to the sieve plate 131. As the vibration imparting device 132 transmits the generated vibration to the sieve plate 131, it may assist the contents (such as metal powder) to be transferred to powder feeder efficiently. The adaptor 100 may include such tools 131, 132 optionally. In some instances, the second bottle 430 may be coupled with one or more valves 400A, 400B to minimize exposures to ambient gas or according to a required specification of the machine in use, as shown in FIGS. 5A and 5B. The valve 400A, 400B may be closed or opened by manipulating handles 410, 420 attached thereto.

In some instances, the diameter of the content 130 body may be greater than the diameters of the first open end 135 at the first neck 136 and the second open end 140 at the second neck 141 of the container 130, so the sieve plate 131 may be placed and installed at lower portion of the container 130. In another exemplary of the embodiment, the sieve plate 131 may be placed and installed at upper portion of the container 130, but not limited to.

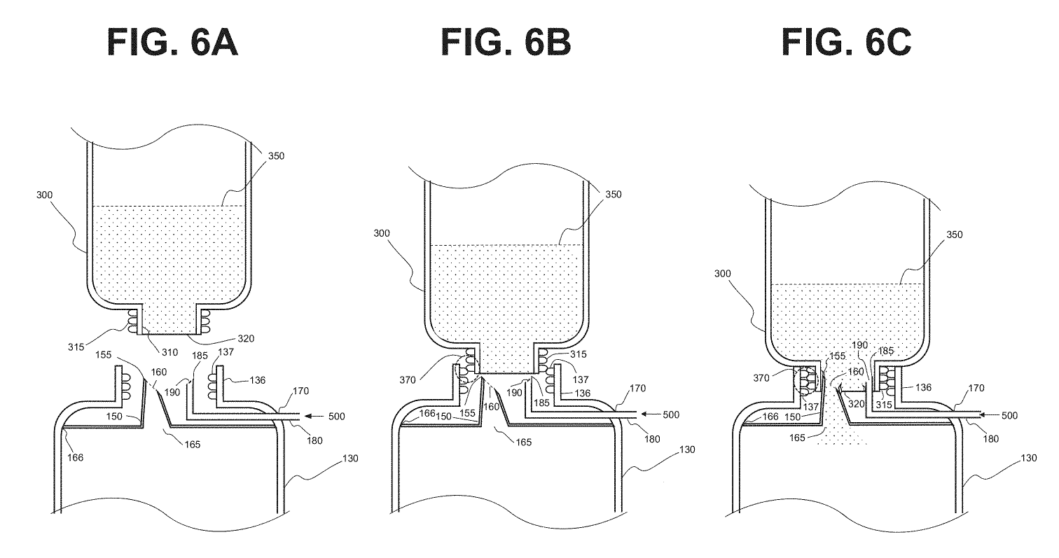

Referring now to FIGS. 6A to 6C, schematic flowsheets depicting the assembly steps of an embodiment utilizing a piercing unit 150 and a conduit 180 is described. In the exemplary of the embodiment, a contents dispensing adaptor 100B with an inner threaded inlet 137 is disclosed herein. There may be a neck finish specification for standard closures, although the factory sealed content bottle shape and its neck diameter vary per manufacturer. If the bottle neck sizes of an adapter for dispensing content with threaded sealing mechanism 100B and a factory sealed content bottle 300 match, then it may be able to initiate to engage the inlets of the factory sealed content bottle 300 and the contents dispensing adaptor 100B. In some implements, the diameter of the first open end of the contents dispensing adaptor may greater than that of the factory sealed content bottle, or may smaller than that of the factory sealed content bottle.

In case that the neck finish of the adapter (such as a first open end 135 on top of the container 130) and the neck finish of the factory sealed content bottle (such as diameter of a neck 310) are able to engage with each other due to their specifications, first, hold the factory sealed content bottle 300 upside down and insert it into the adapter for dispensing content with threaded sealing mechanism 100B. The factory sealed content bottle 300 is yet wearing a sealing 320 to prevent to exposure to ambient gas. Prior to initiate transferring contents 350 from a factory sealed content bottle 300 to a second bottle 430, for example, the adapter for dispensing content 100A, 100B should be coupled to the second bottle 430 prior to engage with the factory sealed content bottle 300. In some instances, the heights of the sharp tips 155, 185 of the piercing unit 150 and the conduit 180 may be the same, or the height of the sharp tip 155 of the piercing unit 150 may be lower or higher than that of the conduit 180.

Once the sealing of the factory sealed content bottle 300 is noticed to place on to the sharp tips 155, 185 of the piercing unit 150 and the conduit 180, then the factory sealed content bottle 300 may begin to rotate so that the factory sealed content bottle 300 and the adapter for dispensing content with threaded sealing mechanism 100B can be joined together, as shown in FIG. 6B.

As the factory sealed content bottle 300 being inserted to the content dispensing adaptor 100B by screwing threads 315, 137, the sealing 320 of the factory sealed content bottle 300 is not yet pierced until the external thread 315 of the factory sealed content bottle 300 is begin to engage with the internal thread 137 of the content dispensing adaptor 100B. The sharp tips 155, 185 of the piercing unit 150 and the conduit 180 come to tear the firmly attached sealing 320 of the factory sealed content bottle 300 by engaging 370 the external screw threads 315 on its neck 310 with the internal screw threads 137 on the inner first neck 136 of the adapter for dispensing content with threaded sealing mechanism 100B.

As shown in FIG. 6C, in some instances, as inert gas 500 provided through the conduit 180 may fluidize in the factory sealed content bottle 300, the content 350, it may be possible to facilitate dispensing of contents 350, such as metal powder, into the adapter for dispensing content with threaded sealing mechanism 100B through the upper open end 160 and the lower open end 165 of the piercing unit 150.

As described above, an optional sieve plate may be placed in the lower, upper, or intermediate portion of the interior container to filter and remove any debris in the perforated seal or aggregated particles of the transferred contents from the factory sealed content bottle.

The present disclosure is to be considered as an exemplification of the principles of the invention and is not intended to limit the invention to the specific embodiments illustrated. In this respect, it is to be understood that the invention is not limited in its application to the details of construction and to the arrangements of components set forth above and below, illustrated in the drawings, or as described in the examples. Systems, methods and apparatuses consistent with the present invention are capable of other embodiments and of being practiced and carried out in various ways.

Other aspects and embodiments of the present invention may be obvious having viewed this particular detailed description of the present invention. However, this detailed description is intended to be educational and instructive and is not intended to be limiting upon the scope and content of the following claims. For example, the adapter for dispensing content may have configurations other than the embodiments of the support apparatus 100A, 100B shown in FIGS. 1-6C. In alternate embodiments (not shown), the adapter for dispensing content may be a combined one with the inflatable sealing mechanism and the threaded sealing mechanism. Accordingly, the invention is not limited except as by the appended claims.

Although the invention has been described with respect to specific embodiments thereof, these embodiments are merely illustrative and not restrictive of the invention. In the description herein, numerous specific details are provided, such as examples of electronic components, electronic and structural connections, materials, and structural variations, to provide a thorough understanding of embodiments of the present invention. One skilled in the relevant art will recognize, however, that an embodiment of the invention can be practiced without one or more of the specific details, or with other apparatus, systems, assemblies, components, materials, parts, etc. In other instances, well-known structures, materials, or operations are not specifically shown or described in detail to avoid obscuring aspects of embodiments of the present invention. In addition, the various Figures are not drawn to scale and should not be regarded as limiting.

Reference throughout this specification to “one embodiment”, “an embodiment”, or a specific “embodiment” means that a particular feature, structure, or characteristic described in connection with the embodiment is included in at least one embodiment of the present invention and not necessarily in all embodiments, and further, are not necessarily referring to the same embodiment. Furthermore, the particular features, structures, or characteristics of any specific embodiment of the present invention may be combined in any suitable manner and in any suitable combination with one or more other embodiments, including the use of selected features without corresponding use of other features. In addition, many modifications may be made to adapt a particular application, situation or material to the essential scope and spirit of the present invention. It is to be understood that other variations and modifications of the embodiments of the present invention described and illustrated herein are possible in light of the teachings herein and are to be considered part of the spirit and scope of the present invention.

It will also be appreciated that one or more of the elements depicted in the Figures can also be implemented in a more separate or integrated manner, or even removed or rendered inoperable in certain cases, as may be useful in accordance with a particular application. Integrally formed combinations of components are also within the scope of the invention, particularly for embodiments in which a separation or combination of discrete components is unclear or indiscernible. In addition, use of the term “coupled” herein, including in its various forms such as “coupling” or “couplable”, means and includes any direct or indirect electrical, structural or magnetic coupling, connection or attachment, or adaptation or capability for such a direct or indirect electrical, structural or magnetic coupling, connection or attachment, including integrally formed components and components which are coupled via or through another component.

Furthermore, any signal arrows in the drawings/Figures should be considered only exemplary, and not limiting, unless otherwise specifically noted. Combinations of components of steps will also be considered within the scope of the present invention, particularly where the ability to separate or combine is unclear or foreseeable. The disjunctive term “or”, as used herein and throughout the claims that follow, is generally intended to mean “and/or”, having both conjunctive and disjunctive meanings (and is not confined to an “exclusive or” meaning), unless otherwise indicated. As used in the description herein and throughout the claims that follow, “a”, “an”, and “the” include plural references unless the context clearly dictates otherwise. Also as used in the description herein and throughout the claims that follow, the meaning of “in” includes “in” and “on” unless the context clearly dictates otherwise.

“optional” or “optionally” means that the subsequently described event or circumstance may or may not occur, and that the description includes instances where the event occurs and instances where it does not.

The foregoing description of illustrated embodiments of the present invention, including what is described in the summary or in the abstract, is not intended to be exhaustive or to limit the invention to the precise forms disclosed herein. From the foregoing, it will be observed that numerous variations, modifications and substitutions are intended and may be effected without departing from the spirit and scope of the novel concept of the invention. It is to be understood that no limitation with respect to the specific methods and apparatus illustrated herein is intended or should be inferred. It is, of course, intended to cover by the appended claims all such modifications as fall within the scope of the claims.

What is claimed is:

1. An apparatus for dispensing content comprising:
a container having a first open end on top, a second open end on bottom, and a side wall;
a piercing unit having a tubular body, a sharp tip at an upper open end configured to tear a sealing of a first factory sealed content bottle, and a lower open end to transfer contents from the first factory sealed content bottle to the container;
a conduit having a sharp tip at a proximal end configured to tear the sealing of the first factory sealed content bottle and an L-shaped frame that penetrates a side wall of the container configured to provide gas into the first factory sealed content bottle;
a cap coupled to the first open end of the container configured to secure the piercing unit and the conduit, and further configured to prevent external materials from entering the container; and
an inflatable bladder attached to the outer first mouth opening configured to seal the first factory sealed content bottle through surrounding it.

2. The apparatus of claim 1, the first open end is on top of a first neck at upper portion of the container and the second open end is on bottom of a second neck at the lower portion of the container.

3. The apparatus of claim 1, wherein the side wall of the container comprises a diameter greater than the diameter of the first open end and the second open end, and the container further comprises the upper portion that the sidewall tapers towards the first open end and the lower portion that the sidewall tapers towards the second open end.

4. The apparatus of claim 2, wherein the first open end is configured to couple to the first factory sealed content bottle and the second open end is configured to connect to a second bottle or a valve coupled with the second bottle.

5. The apparatus of claim 4, wherein the second bottle is a designated container which meets a certain machine specification.

6. The apparatus of claim 1, wherein the piercing unit further comprises a greater diameter of the lower end than a diameter of the upper end.

7. The apparatus of claim 1, wherein the gas provided through the conduit comprises inert gas.

8. The apparatus of claim 7, wherein the inert gas is configured to fluidize content within the factory sealed content bottle.

9. The apparatus of claim 1, wherein the cap further comprises a cross-sectioned supporter to secure the piercing unit and the conduit.

10. The apparatus of claim 1, wherein the container further comprises a sieve plate disposed at the lower portion of the container configured to filter one or more pierced and/or torn sealing debris from the first factory sealed content bottle and to break up agglomerated particles therein.

11. The apparatus of claim 10, wherein the apparatus for dispensing content further comprises a vibration imparting device attached to the outer container, and the vibration imparting device generates vibration and transmits the vibration to the sieve plate.

12. The apparatus of claim 1, wherein the inflatable bladder further having a rigid outer shell, an inflatable inner shell, and a first aperture of the outer shell configured to pressurize into the shell.

13. The apparatus of claim 1, wherein the first aperture of the outer shell is an air injection inlet, the air injection inlet further connected to an air pump or an air compressor.

14. The apparatus of claim 1, wherein the container comprises a cylindrical side wall.

15. An apparatus for dispensing content comprising:
a container having a first open end on top of a first neck at upper portion of the container, a second open end on bottom of a second neck at the lower portion of the container, and a side wall;
an internal screw thread on the first open end for engaging with an external screw thread of a first factory sealed content bottle;
a piercing unit having a sharp tip at an upper end configured to tear a sealing of the first factory sealed content bottle, a lower end extended to the side wall of the container configured to fix the piercing unit to the side wall of the container, and a tubular body configured to transfer content from the first factory sealed content bottle to the container; and
a conduit having a sharp tip at an upper end configured to tear the sealing of the first factory sealed content bottle and an L-shaped frame that penetrates a side wall of the container configured to provide gas into the first factory sealed content bottle, wherein the conduit being located above the lower end of the piercing unit.

16. The apparatus of claim 15, wherein the first open end of the first neck is configured to couple to a neck mouth of the first factory sealed content bottle, the second open end of the second neck is configured to connect to an inlet of a second bottle to which the content is to be transferred or to a valve configured to couple to the second bottle.

17. The apparatus of claim 15, wherein the gas provided through the conduit is inert gas and the gas is configured to fluidize the content in the first factory sealed content bottle.

18. The apparatus of claim 15, wherein the upper end of the piercing unit and the upper end of conduit are positioned above a height of the first open end of the container configured to pierce the sealing of the first factory sealed content bottle.

19. The apparatus of claim 15, wherein the container further comprises a sieve plate disposed at the lower portion of the container configured to filter one or more pierced and/or torn sealing debris from the first factory sealed content bottle and to break up agglomerated particles therein.

20. The apparatus of claim 19, wherein the apparatus for dispensing content further comprises a vibration imparting device attached to the outer container, and the vibration imparting device generates vibration and transmits the vibration to the sieve plate.
